(19) United States
(12) Patent Application Publication
(10) Pub. No.: US 2008/0259091 A1
(43) Pub. Date: Oct. 23, 2008

(54) System and Method for Enhancing the Contrast Ratio of an Image

(75) Inventors: Mark Rumreich, Indianapolis, IN (US); John Hague, Indianapolis, IN (US)

Correspondence Address: FLETCHER YODER P.C., 7915 FM 1960 RD. WEST, SUITE 330, HOUSTON, TX, 77070, US

(73) Assignee: TTE TECHNOLOGY, INC., Indianapolis, IN (US)

(21) Appl. No.: 12/093,309

(22) PCT Filed: Nov. 14, 2005
(86) PCT No.: PCT/US2005/041720

§ 371 Date: May 9, 2008

(51) Int. Cl. G09G 3/36

(52) U.S. Cl. 345/601

(57) ABSTRACT

The disclosed embodiments relate to a system and method that enhance the contrast ratio of a display device. An exemplary embodiment comprises determining brightness level of a brightest object of a video frame, determining a required illumination for the video frame based on the pixel brightness level of the brightest object, obtaining a gamma-corrected pixel adjustment value, applying the gamma-corrected pixel adjustment value to a color value of an input pixel of the video frame to obtain a gamma-corrected pixel value, and displaying the gamma-corrected pixel value.

### FIELD OF THE INVENTION

The present invention relates generally to display systems. More specifically, the present invention relates to a system and method for enhancing contrast ratio in certain display systems.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Liquid Crystal Displays (LCD) panels are increasingly being used for television display applications mainly due to their light weight and thin profile, as compared to Cathode Ray Tubes (CRTs). However, the performance of LCD panels is still lagging behind CRTs in a number of key areas, one of which is contrast ratio. As an example, the contrast ratio of high-end LCD panels is generally about 500:1, while for a CRT, 10,000:1 is a common ratio.

The contrast ratio may be defined as the ratio of the amount of light of the brightest white to the darkest black of a video frame. Unfortunately, due to their light transmitting properties, pixels of LCD panels transmit enough light, even when in their darkest state, such that a black colored pixel displayed on the LCD panel actually appears to be displayed as a dark gray pixel. Consequently, this significantly lowers the contrast ratio of the LCD panel, which may be more objectionable in low light viewing conditions.

Furthermore, LCD panels are designed to have a nonlinear output characteristic similar to that of a CRT display. As one skilled in the art would appreciate, such a nonlinear trait corresponds to a well-known gamma characteristic of the LCD/CRT display. The gamma characteristic of the LCD panel further complicates contrast ratio enhancement thereof.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

The disclosed embodiments relate to a system and method that enhance the contrast ratio of a display device. An exemplary embodiment comprises determining brightness level of a brightest object of a video frame, determining a required illumination for the video frame based on the pixel brightness level of the brightest object, obtaining a gamma-corrected pixel adjustment value, applying the gamma-corrected pixel adjustment value to a color value of an input pixel of the video frame to obtain a gamma-corrected pixel value, and displaying the gamma-corrected pixel value.

### BRIEF DESCRIPTION OF THE DRAWINGS

Advantages of the invention may become apparent upon reading the following detailed description and upon reference to the drawings in which:

FIG. 1 is a block diagram of an LCD panel in accordance with embodiments of the present invention;

FIG. 2 is a block diagram of a contrast ratio enhancing system in accordance with embodiments of the present invention;

FIG. 3 is a block diagram of a pixel modifying system in accordance with embodiments of the present invention;

FIG. 4 is a block diagram of an exemplary embodiment of an RGB contrast channel in accordance with the present invention; and

FIG. 5 is flow chart depicting a method for enhancing contrast ratio in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

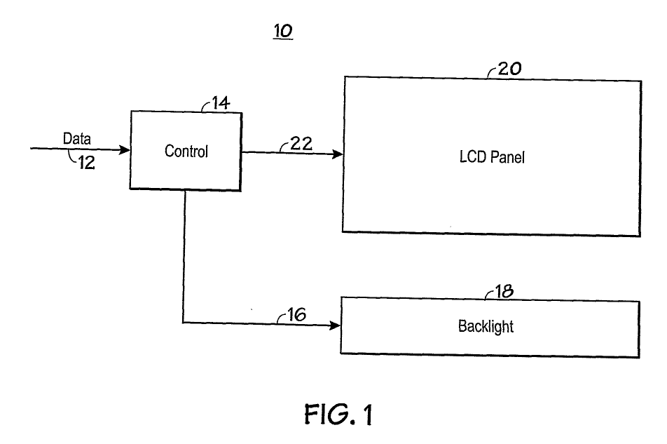

Referring to FIG. 1, a configuration of an exemplary LCD panel system 10 in accordance with an embodiment of the present invention is shown. The figure depicts an LCD panel 20 and a backlight 18 controlled by a control system 14. The control system 14, receives data 12, which may include video backlight illumination and liquid crystal pixel data values. The control system 14 may use the data 12 to simultaneously adjust the backlight and the pixel values to enhance the contrast ratio of the LCD panel 20. Accordingly, data 22 outputted by the control system 14 goes into the LCD panel 20 for adjusting the pixel values. Similarly, data 16 outputted by the control system 14 is transmitted into the backlight 18 for adjusting the backlight illumination of the video.

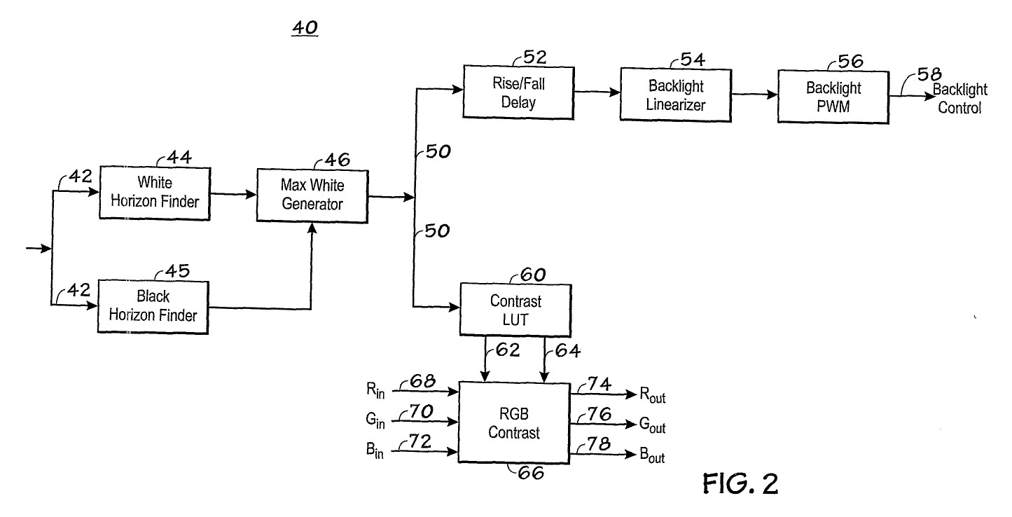

Turning now to FIG. 2, a contrast ratio enhancement control system 40 in accordance with an embodiment of the present invention is shown. The description set forth of the control system 40 pertains to components controlling the video backlight illumination and the pixel values of the LCD panel 20. Accordingly, a white horizon finder 44 and a black horizon finder 45 receive respective backlight illumination component data 42. The white horizon finder 44 and the black horizon finder 45 respectively determine statistical information relating to the brightness, and near dark levels, and their distribution throughout a video frame. Information obtained by the white horizon finder 44 and the black horizon finder 45 is outputted to a maximum white generator 46. The maximum white generator 46 simultaneously controls the backlight illumination and the liquid crystal pixel values. In accordance with embodiments of the present invention, the two are adjusted in a complimentary fashion to enhance the contrast ratio of the LCD panel 20.

The maximum white generator 46 adjusts the backlight illumination by determining the brightness of the brightest area of the video frame. This information is then utilized to illuminate the LCD panel 20, for example by cold-cathode-fluorescent (CCF) lamps. Accordingly, to improve the contrast ratio, a reduced backlight illumination is desired. However, as one of ordinary skilled in the art would appreciate, reducing the backlight illumination too much may cause an undesired “white reduction” of the video frame. In order to avoid this, brightness information obtained by the maximum white generator 46 is further utilized to modify the pixel values of the LCD panel to compensate for possible insufficient backlight illumination.

The maximum white generator 46 outputs data 50, used to simultaneously adjust the backlight illumination data and RGB input values of the LCD panel 20. The data 50 may be inputted into backlight control circuitry, which outputs backlight control data 58. Such backlight control circuitry may include: a rise/fall delay 52 which compensates for time alignment problems between the backlight illumination and the pixel values. This may prevent viewer perceived white flashes appearing on a screen, as appreciated by those skilled in the art. Also included in the backlight control circuitry are a backlight linearizer 54 which compensates for nonlinearity in the light characteristic of the backlight, and a backlight pulse width modulator (PWM) 56 which controls the illumination level of the backlight.

Further, to compensate for backlight illumination, maximum white data 50 is outputted by the maximum white generator 46 for modifying the pixel values of the LCD panel 20 in a non-linear gamma-corrected domain. Accordingly, the data 50 is inputted into a contrast look-up table (CLUT) 60. In an exemplary embodiment of the present invention, the CLUT 60 produces adjustment values that are inversely proportional to the maximum white data 50 raised to the 1/gamma power, or as given by the relation:

$$CLUT COEFFICIENTS ∝ \frac{1}{{( MAX WHITE )}^{\frac{1}{γ}}}$$

As appreciated by those skilled in the art, the forgoing relationship between the CLUT 60 adjustment values and data generated by the maximum white generator 46, as described by the above relation, is exact for display devices conforming to an ideal gamma curve. Indeed, a majority of the input light signals do conform to the ideal gamma curve, which may be described by a non-linear function or a combination of multiple non-linear functions. This renders the above relationship a very good first order approximation for all input signals. However, to improve the accuracy of the gamma correction beyond the non-linear approximation, the CLUT 60 adjustment values are also configured to accommodate display devices conforming to a non-ideal gamma curve or those that may deviate from the ideal gamma curve. For example, this may correspond to display devices conforming to a portion of the gamma curve described by a linear function or a combination of multiple linear functions. Thus, the adjustment values generated by the CLUT 60 may deviate from the above relation to accommodate a full span of the gamma curve.

Thus, the adjustment values produced by the CLUT 60 are outputted as red, green, blue (RGB) offset 62 and RGB gain-value 64. The RGB offset value 62 and the RGB gain-value 64 are inputted into an RGB contrast 66. Accordingly, input RGB pixel values 68-72 are combined with the RGB offset 62 and the RGB gain-value 64 to output gamma-corrected RGB pixel values 74-78.

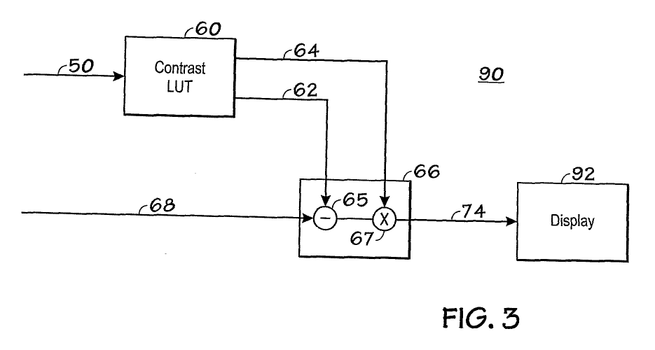

Referring to FIG. 3, a more detailed depiction of a pixel value modification technique in the nonlinear gamma corrected domain is shown. As illustrated by FIG. 3, data 50 outputted by the maximum white generator 46 is inputted into the CLUT 60 to produce adjustment values in the non-linear gamma corrected domain. These adjustment values are then outputted in a form of the RGB offset data 62 and the RGB gain-value data 64. Upon receiving the later inputs, the RGB contrast 66 employs a subtractor 65 and a multiplier 67 to adjust the pixel values. Accordingly, the subtractor 65 is configured to subtract the RGB offset data 62 from input pixel values 68-72. This later value is then multiplied by RGB gain-value data 64 to obtain the output pixels 74-78. In doing so, RGB input pixels 68-72 are adjusted to compensate for pixels having light levels conforming to the ideal gamma curve, and for pixels having light levels which may deviate from it.

As illustrated in FIG. 3, the subtractor 65 and the multiplier 67 transform the exemplary R pixel value 68 via data 62 and 64 into gamma-corrected pixel value 74. A similar pixel modification scheme can also respectively be applied to the G and B pixels values 70 and 72 to produce their respective modified values 76, 78. The foregoing gamma correction scheme of pixel values intended to compensate for backlight illumination can be described mathematically by an equation of the form:

RGB OUTPUT=(RGB INPUT−RGB OFFSET)×RBG GAIN

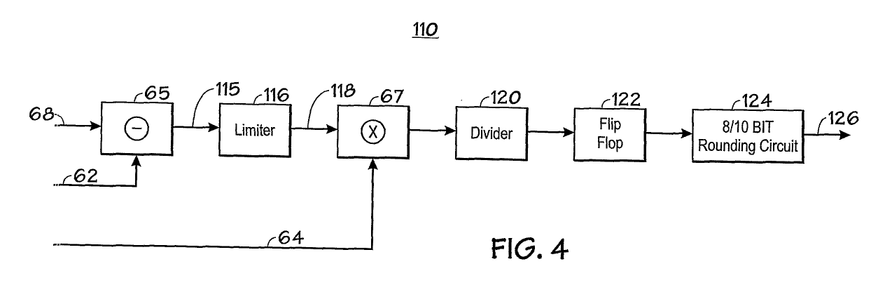

Referring now to FIG. 4, an exemplary embodiment of the RGB contrast 66 in accordance with the present invention is illustrated. In this embodiment exemplary processing steps executed by the RGB contrast 66 for generating modified pixel values in response to the whitest object of the video frame are depicted. Accordingly, the exemplary R pixel value 68 inputted into subtractor 65 is combined with RGB offset data 62 generated by the CLUT 60 to generate gamma-corrected offset compensations for the pixel value 68. Consequently, data 115 is outputted from the subtractor 65 and inputted into limiter 116 to ensure the data 115 falls in a prescribed range of values for further processing. Hence, resulting data 118 is inputted into the multiplier 67 together with the RGB gain-value data 64 for generating gamma-corrected gain compensations.

Thereafter, data generated by multiplier 67 is first processed by a divider 120 which disposes excess bits, and then processed by a bistable gate 122 also known as a flip-flop. Data generated by the flip-flop 122 may be inputted into an eight or a ten bit rounding circuitry 124. The choice between 8 or 10 bit may depend on system characteristics and requirements, as would be appreciated to those of ordinary skilled in the art.

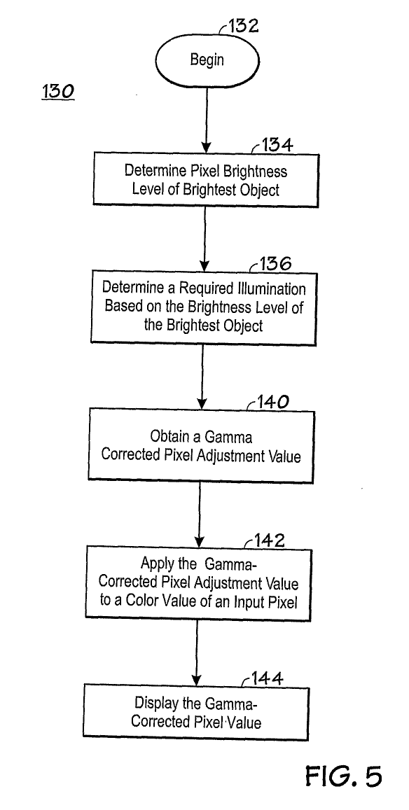

FIG. 5 is a flow chart comprising blocks outlining steps of method for enhancing contrast ratio in accordance with embodiments of the present technique. The flow chart is generally referred to by the reference numeral 130. After brightness information of the video frame has been obtained, the method begins at block 132. Thereafter, this information is employed at block 134 to determine pixel brightness level of the brightest object in the video frame. Once data 134 is obtained, a required illumination based on the brightness level of the brightest object is determined, as denoted by block 136. This data is further used at block 140 to obtain a gamma corrected pixel adjustment value. Thereafter, the gamma corrected pixel adjustment value is applied at block 142 to a color value of an input pixel. Finally, a gamma corrected color pixel value is outputted and displayed, as indicated by block 144.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method of enhancing a contrast ratio of a display device, the method comprising:
determining a pixel brightness level of a brightest object of a video frame;
determining a required illumination for the video frame based on the pixel brightness level of the brightest object;
obtaining a gamma-corrected pixel adjustment value;
applying the gamma-corrected pixel adjustment value to a color value of an input pixel of the video frame to obtain a gamma-corrected pixel value; and
displaying the gamma-corrected pixel value.

2. The method, as set forth by claim 1, comprising using statistical information to determine the pixel brightness level of the brightest object of the video frame.

3. The method, as set forth by claim 1, comprising controlling the pixel brightness level by a backlight control.

4. The method, as set forth by claim 1, comprising controlling simultaneously the pixel brightness level and the color value of the input pixel.

5. The method, as set forth by claim 1, comprising obtaining from a contrast look up table (CLUT) the gamma-corrected pixel adjustment values.

6. The method as set forth by claim 5, comprising multiplying the color value of the input pixel by the CLUT to obtain color value of the output pixel.

7. The method, as set forth by claim 1, comprising adjusting the required illumination in accordance with an ideal gamma curve.

8. The method, as set forth by claim 1, comprising adjusting the required illumination in accordance with a non-ideal gamma curve.

9. A system that enhances a contrast ratio of a display device, the system comprising:
a white horizon finder that is adapted to determine pixel brightness level of a brightest object of a video frame;
a maximum whiteness generator that is adapted to determine a required illumination for the video frame based on the brightness level of the brightest object;
a structure that is adapted to receive a signal corresponding to the brightness level of the brightest object and, responsive thereto, to obtain a gamma-corrected pixel adjustment value; and
an RGB contrast device that is adapted to apply the gamma-corrected pixel adjustment value to a color value of an input pixel of the video frame to obtain a gamma-corrected pixel value and to provide the gamma-corrected pixel value to a display screen.

10. The system, as set forth by claim 9, comprising cold-cathode-fluorescent (CCF) lamps adapted to generate brightness levels of the video frame.

11. The system, as set forth by claim 9, comprising a backlight control adapted to control the brightness of the video frame.

12. The system, as set forth by claim 9, wherein the required illumination value is simultaneously inputted to the backlight control and to the RGB contrast.

13. The system, as set forth by claim 9, wherein the structure comprises a contrast look-up table (CLUT) adapted to obtain the gamma-corrected pixel adjustment value.

14. The system, as set forth by claim 9, wherein the RGB contrast device comprises a multiplier adapted to obtain the gamma corrected pixel.

15. The system, as set forth by claim 9, wherein the RGB contrast device comprises a subtractor adapted to obtain the gamma corrected pixel.

16. The system, as set forth by claim 9, wherein the structure is adapted to receive statistical information relating to near dark levels of pixels in a video frame.

17. A system for enhancing a contrast ratio of a display device, comprising:
means for determining a pixel brightness level of a brightest object of a video frame;
means for determining a required illumination for the video frame based on the pixel brightness level of the brightest object;
means for obtaining a gamma-corrected pixel adjustment value;
means for applying the gamma-corrected pixel adjustment value to a color value of an input pixel of the video frame to obtain a gamma-corrected pixel value; and
means for displaying the gamma-corrected pixel value.

18. The system, as set forth by claim 17, comprising means for controlling simultaneously the pixel brightness level and the color value of the input pixel.

19. The system, as set forth by claim 17, comprising means for obtaining from a contrast look up table (CLUT) the gamma-corrected pixel adjustment values.

20. The method as set forth by claim 19, comprising means for multiplying the color value of the input pixel by the CLUT to obtain color value of the output pixel.
